(19) United States
(12) Patent Application Publication
(10) Pub. No.: US 2025/0250840 A1
(43) Pub. Date: Aug. 7, 2025

(54) SELF-LEARNING POWER DOOR CYCLE AND COMPENSATION FOR REDUCED SEAL LOAD

(71) Applicant: MAGNA CLOSURES INC., Newmarket (CA)

(72) Inventor: Ryan HERMAN, Newmarket (CA)

(21) Appl. No.: 19/044,163

(22) Filed: Feb. 3, 2025

Related U.S. Application Data
(60) Provisional application No. 63/549,468, filed on Feb. 3, 2024.

(51) Int. Cl. E05F 15/622; E05B 81/20

(52) U.S. Cl. CPC E05F 15/622; E05B 81/20; E05Y 2400/30; E05Y 2400/358; E05Y 2400/36; E05Y 2900/531

(57) ABSTRACT

A power closure member actuation system for moving a closure member of a vehicle between an open position and a closed position relative to a vehicle body. The system includes an actuator configured to move the closure member relative to the vehicle body. The system further includes a closure member feedback sensor for determining at least one of a position and a speed of the closure member. A controller is in communication with the closure member feedback sensor and the actuator. The controller is configured to control movement of the closure member by the actuator while sensing the speed of the closure member using the closure member feedback sensor. The controller is also configured to adjust the speed of the closure member moving toward the closed position to account for a seal load of at least one closure member seal varying over a life of the vehicle.

### CROSS-REFERENCE TO RELATED APPLICATION

This application claims the benefit of U.S. Provisional Application Ser. No. 63/549,468, filed Feb. 3, 2024, which is incorporated herein by way of reference in its entirety.

### FIELD

The present disclosure relates generally to closure member systems for motor vehicles and, more particularly, to a power closure member actuation system for moving a closure member, such as a vehicle door, relative to a vehicle body between an open position and a closed position.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define the pivot axis. Such swinging passenger doors (“swing doors”) have recognized issues such as, for example, when the vehicle is situated on an inclined surface and the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding the door in one or more mid-travel positions in addition to a fully-open position. In some high-end vehicles, the door hinge may include an infinite door check mechanism which allows the door to be opened and held in check at any desired open position. One advantage of passenger doors equipped with door hinges having an infinite door check mechanism is that the door can be located and held in any position to avoid contact with adjacent vehicles or structures.

As a further advancement, power closure member actuation systems have been developed. For passenger doors, like those described above, the power closure member system can function to automatically swing the passenger door about its pivot axis between the open and closed positions, to assist the user as he or she moves the passenger door, and/or to pop out or present the passenger door to the user. Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Schuering et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

Closure members moved by such power closure member actuation systems commonly also include seals between the closure member and the vehicle body (e.g., around a perimeter of the closure member) to help isolate an interior of the vehicle from an environment. As the closure members are operated, the seals provide some load based on their resilience that can affect movement of the closure member. For example, the power closure member actuation system may need to work against the seal when closing the closure member. Nevertheless, as the seals age, the load or resilience provided can fluctuate from a new or “green” seal to the end of the vehicle life, as well as in different temperatures, for example. Consequently, variability of seal load can adversely affect consistent performance of the power closure member actuation system.

In view of the above, there remains a need to develop alternative power closure member actuation systems and methods of operation which address and overcome limitations and drawbacks associated with known power closure member actuation systems as well as to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a power closure member actuation system for moving a closure member of a vehicle between an open position and a closed position relative to a vehicle body. The closure member is sealed by at least one closure member seal disposed between the closure member and the vehicle body. The system includes an actuator coupled to the closure member and the vehicle body configured to move the closure member relative to the vehicle body. The system further includes a closure member feedback sensor for determining at least one of a position and a speed of the closure member. A controller is in communication with the closure member feedback sensor and the actuator. The controller is configured to control movement of the closure member by the actuator while sensing the speed of the closure member using the closure member feedback sensor. The controller is also configured to adjust the speed of the closure member moving toward the closed position to account for a seal load of the at least one closure member seal varying over a life of the vehicle.

It is a further aspect for the present disclosure to provide a method of operating a power closure member actuation system for moving a closure member of a vehicle between an open position and a closed position relative to a vehicle body. The closure member is sealed by at least one closure member seal disposed between the closure member and the vehicle body. The method includes the step of controlling movement of the closure member by an actuator while sensing a speed of the closure member using a closure member feedback sensor. The method also includes the step of adjusting the speed of the closure member moving toward the closed position to account for a seal load of the at least one closure member seal varying over a life of the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and the vehicle body according to aspects of the disclosure;

FIG. 2 is a perspective inner side view of a closure member shown in FIG. 1, with various components removed for clarity purposes only, in relation to a portion of the vehicle body and which is equipped with the power closure member actuation system according to aspects of the disclosure; and

FIGS. 3-5 illustrate steps of a method of operating a power closure member actuation system for moving a closure member of a vehicle between an open position and a closed position relative to a vehicle body according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a power closure member actuation system and method of operating the power closure member actuation system constructed in accordance with the teachings of the present disclosure will now be disclosed. The example embodiment is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

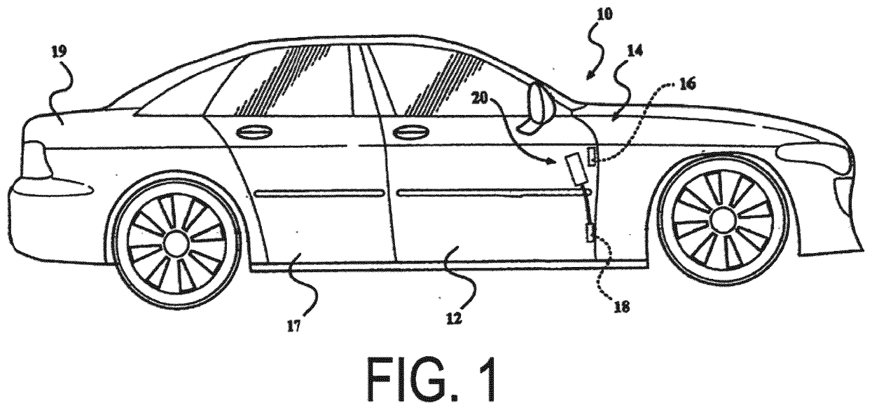

Referring initially to FIG. 1, an example motor vehicle 10 is shown to include a first passenger door 12, or also referred to as an exemplary closure member 12, pivotally mounted to a vehicle body 14 via an upper door hinge 16 and a lower door hinge 18 which are shown in phantom lines. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10 such as rear passenger doors 17 and decklid 19.

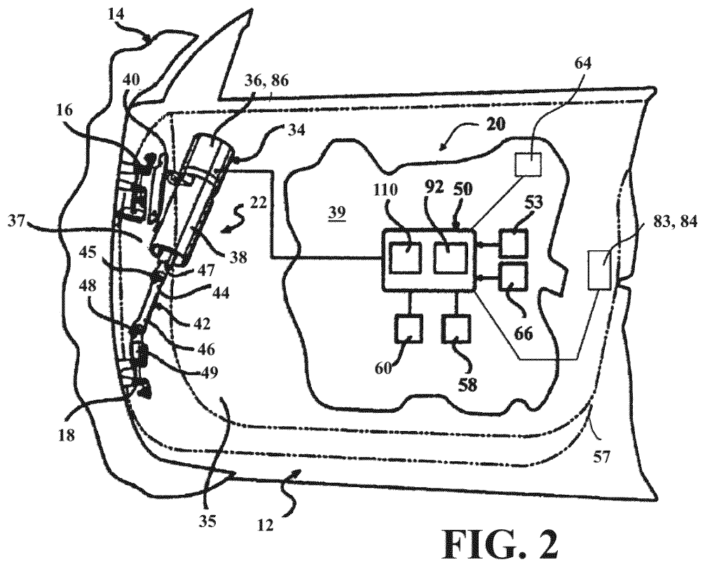

Power closure member actuation system 20 is generally shown in FIG. 2 and, as mentioned, is operable for controllably pivoting vehicle door 12 relative to vehicle body 14 between an open position and a closed position. As best shown in FIG. 2, power closure member actuation system 20 includes a power-operated actuator mechanism 22 having a motor and geartrain assembly 34 that is rigidly connectable to vehicle door 12. Motor and geartrain assembly 34 is configured to generate a rotational force. In the preferred embodiment, motor and geartrain assembly 34 includes an electric motor 36 that is operatively coupled to a speed reducing/torque multiplying assembly, such as a high gear ratio planetary gearbox 38. The high gear ratio planetary gearbox 38 may include multiple stages, thus allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure.

Motor and geartrain assembly 34 includes a mounting bracket 40 for establishing the connectable relationship with vehicle door 12. Mounting bracket 40 is configured to be connectable to vehicle door 12 adjacent to a door-mounted door hinge strap associated with upper door hinge 16. As further shown in FIG. 2, this mounting of motor assembly 34 adjacent to upper door hinge 16 of vehicle door 12 disposes the power-operated actuator mechanism 22 of power closure member actuation system 20 in close proximity to the pivot axis A. The mounting of motor and geartrain assembly 34 adjacent to upper door hinge 16 of vehicle door 12 minimizes the effect that power closure member actuation system 20 may have on a mass moment of inertia (i.e., pivot axis A) of vehicle door 12, thus improving or easing movement of vehicle door 12 between its open and closed positions. In addition, as also shown in FIG. 2, the mounting of motor and geartrain assembly 34 adjacent to upper door hinge 16 of vehicle door 12 allows power closure member actuation system 20 to be packaged in front of an A-pillar glass run channel 35 associated with vehicle door 12 and thus avoids any interference with a glass window function of vehicle door 12. Put another way, power closure member actuation system 20 can be packaged in a portion 37 of an internal door cavity 39 within vehicle door 12 that is not being used, and therefore reduces or eliminates impingement on existing hardware/mechanisms within vehicle door 12. Although power closure member actuation system 20 is illustrated as being mounted adjacent to upper door hinge 16 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes a rotary drive mechanism that is rotatively driven by the power-operated actuator mechanism 22. As shown in FIG. 2, the rotary drive mechanism includes a drive shaft 42 interconnected to an output member of gearbox 38 of motor and geartrain assembly 34 and which extends from a first end 44 disposed adjacent gearbox 38 to a second end 46. The rotary output component of motor and geartrain assembly 34 can include a first adapter 47, such as a square female socket or the like, for drivingly interconnecting first end 44 of drive shaft 42 directly to the rotary output of gearbox 38 In addition, although not expressly shown, a disconnect clutch can be disposed between the rotary output of gearbox 38 and first end 44 of drive shaft 42. In one configuration, the clutch would normally be engaged without power (i.e. power-off engagement) and could be selectively energized (i.e. power-on release) to disengage. Put another way, the optional clutch drivingly would couple drive shaft 42 to motor and geartrain assembly 34 without the application of electrical power while the clutch would require the application of electrical power to uncouple drive shaft 42 from driven connection with gearbox 38. As an alternative, the clutch could be configured in a power-on engagement and power-off release arrangement. The clutch may engage and disengage using any suitable type of clutching mechanism such as, for example, a set of sprags, rollers, a wrap-spring, friction plates, or any other suitable mechanism. The clutch is provided to permit door 12 to be manually moved by the user 75 between its open and closed positions relative to vehicle body 14. Such a disconnect clutch could, for example, be located between the output of electric motor 36 and the input to gearbox 38. The location of this optional clutch may be dependent based on, among other things, whether or not gearbox 38 includes “back-driveable” gearing. In one possible configuration, the power-operated actuator mechanism 22 is provided without a clutch mechanism, and so a direct permanent coupling between the motor and output of the power-operated actuator mechanism 22 (e.g. a coupling to the vehicle body 14 for example.) In such a configuration, the geartrain assembly 34 may possibly be a backdriveable geartrain.

Second end 46 of drive shaft 42 is coupled to a body hinge strap of lower door hinge 18 for directly transferring the rotational force from motor and geartrain assembly 34 to door 12 via the body hinge strap of the lower door hinge 18. To accommodate angular motion due to swinging movement of door 12 relative to vehicle body 14, the rotary drive mechanism further includes a first universal joint or U-joint 45 disposed between first adapter 47 and first end 44 of drive shaft 42 and a second universal joint or U-joint 48 disposed between a second adapter 49 and second end 46 of drive shaft 42. Alternatively, constant velocity joints could be used in place of the U-joints 45, 48. The second adapter 49 may also be a square female socket or the like configured for rigid attachment to the body hinge strap of lower door hinge 18. However, other means of establishing the drive attachment can be used without departing from the scope of the disclosure. Rotation of drive shaft 42 via operation of motor and geartrain assembly 34 functions to actuate lower door hinge 18 by rotating the body hinge strap about its pivot axis to which drive shaft 42 is attached and relative to a door hinge strap. As a result, power closure member actuation system 20 is able to effectuate movement of vehicle door 12 between its open and closed positions by “directly” transferring a rotational force directly to the body hinge strap of lower door hinge 18. With motor and geartrain assembly 34 connected to vehicle door 12 adjacent to upper door hinge 16, second end 46 of drive shaft 42 is attached to the body hinge strap of lower door hinge 18. Based on available space within door cavity 39, it may be possible to mount motor and geartrain assembly 34 adjacent to the door-mounted hinge component of lower door hinge 18 and directly connect second end 46 of drive shaft 42 to the vehicle-mounted hinge component of upper door hinge 16. In the alternative, if motor and geartrain assembly 34 is connected to vehicle body 14, second end 46 of drive shaft 42 would be attached to the door hinge strap of the lower door hinge 18. At least one door seal 57 may extend around at least a portion of a periphery of the closure member 12 and/or opening of the vehicle body 14 associated with the closure member (e.g., vehicle door 12).

The power closure member actuation system 20 also includes a controller 50 that is coupled to the actuator 22 and in communication with other vehicle systems (e.g., a body control module) and also receives vehicle power from the vehicle 10 (e.g., from a vehicle battery 53). The controller 50 includes a processor or other computing unit 110 in communication with the memory device 92. So, the computing unit 110 is coupled to the memory device 92 for storing a plurality of automatic closure member motion parameters for the automatic mode and a plurality of powered closure member motion parameters for the powered assist mode and used by the controller 50 for controlling the movement of the closure member (e.g., door 12).

The controller 50 can also be in communication with the key fob 60 (e.g., wirelessly) and a closure member switch 58 configured to output a closure member trigger signal. The controller 50 is operable in at least one of an automatic mode (in response to an automatic mode initiation input from the user) and a powered assist mode (in response to a motion input from a user). In the automatic mode, the controller 50 commands movement of the closure member 12 through a predetermined motion profile (e.g., to open the closure member 12) stored in the memory device 92. The powered assist mode is different than the automatic mode in that the motion input from the user may be continuous to move the closure member, as opposed to a singular automatic mode initiation input by the user in automatic mode. Such control inputs, such as the automatic mode initiation input and the motion input may also include other types of inputs, such as a wireless command to control the door opening based on a signal such as a wireless signal received from the key fob 60, or other wireless device such as a cellular smart phone, or from a sensor assembly provided on the vehicle, such as a radar or optical sensor assembly detecting an approach of the user, such as a gesture or gait e.g. walk of the user upon approach of the user to the vehicle 10.

In addition, the power closure member actuation system 20 includes at least one closure member feedback sensor 64 for determining at least one of a position and a speed and an attitude of the closure member 12. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the controller 50. Feedback sensor 64 in communication with controller 50 is illustrative of part of a feedback system or motion sensing system for detecting motion of the door directly or indirectly, such as by detecting changes in speed and position of the closure member, or components coupled thereto. For example, the motion sensing system may be hardware based (e.g. a hall sensor unit an related circuitry) for detecting movement of a target on the closure member 12 (e.g. on the hinge 16, 18) or actuator 22 (e.g. on a motor shaft) as examples, and/or may also be software based (e.g. using code and logic for executing a ripple counting algorithm) executed by the controller 50 for example. Other types of position, speed, and/or orientation detectors such as accelerometers and induction based sensors may be employed without limitation.

The power closure member actuation system 20 additionally includes at least one non-contact obstacle detection sensor 66 which may form part of a non-contact obstacle detection system coupled, such as electrically coupled, to the controller 50. The controller 50 is configured to determine whether an obstacle is detected using the at least one non-contact obstacle detection sensor 66 (e.g., using a non-contact obstacle detection algorithm 69) and may, for example, cease movement of the closure member in response to determining that the obstacle is detected. The non-contact obstacle detection system may also be configured to calculate distance from the closure member to the object or obstacle, or to a user as the object or obstacle, to the door 12. For example non-contact obstacle detection system may be configured to perform time of flight calculations to determine distance using a radar based sensor 66 or to characterize the object as a user or human as compared to an non-human object for example based on determining the reflectivity of the object using a radar based sensor 66 and system. The non-contact obstacle detection system may also be configured determine when an obstacle is detected, for example by detecting reflected waves of the object or obstacle or user of radar transmitted from the obstacle sensor 66. The non-contact obstacle detection system may also be configured determine when an obstacle is not detected, for example by not detecting reflected waves of the object or obstacle or user of radar transmitted from the obstacle sensor 66. The operation and example of the at least one non-contact obstacle detection sensor 66 and system are discussed in U.S. Patent Application No. 2018/0238099, incorporated herein by reference.

The controller 50 may also be in communication with a vehicle latch 83 configured to selectively secure the closure member 12 to the vehicle body 14 in the closed position, for example. Latch 83 is movable between a latch primary position in which the closure member 12 is located in the closed position (i.e., fully closed or “hard closed”) and a latch secondary position in which the closure member 12 is located in a partially closed position (i.e., “soft closed”) between the open position and the closed position. It should be appreciated that the control techniques described herein can be achieved on power closure member actuation systems 20 where the latch 83 is and is not part of the system 20.

As discussed, the closure member 12 can be sealed by at least one closure member seal 57 disposed between the closure member 12 and the vehicle body 14. However, over time, a seal load of the at least one closure member seal 57 may decrease. Consequently, there is a risk of the closure member 12 traveling directly to the primary latch position (instead of secondary position). Thus, according to an aspect of the disclosure, the controller 50 is configured to control movement of the closure member 12 by the actuator 22 while sensing the speed of the closure member 12 using the closure member feedback sensor 64. The controller 50 is also configured to adjust the speed of the closure member 12 moving toward the closed position to account for a seal load of the at least one closure member seal 57 varying over a life of the vehicle 10 (e.g., due to the at least one closure member seal 57 or due to temperature). Therefore, according to another aspect, the controller 50 is further configured to adjust the speed of the closure member 12 moving toward the closed position to prevent the closure member 12 from moving the vehicle latch 83 directly to the latch primary position.

The vehicle latch 83 can include a cinch motor 84 coupled to a ratchet of the vehicle latch 83 for cinching the closure member 12 into the closed position from the partially closed position. Such operation is known as “soft close”. The adjusting the speed of the closure member 12 moving toward the closed position to account for the seal load varying discussed herein maintains soft close (cinch) performance over the life of the vehicle 10 as the seal load changes.

As discussed, the actuator 22 includes an electric motor 36 operably coupled to the closure member 12. According to an aspect, the power closure member actuation system 20 can further include a motor current sensor 86 coupled to the electric motor 36 for sensing a current provided to the electric motor 36 during movement of the closure member 12. The memory device 92 can store a predetermined motion profile of the speed of the closure member 12 versus a predetermined motion time period and a predetermined current profile of the current of the electric motor 36 versus a predetermined current time period. Closing speed of the closure member 12 is calibrated proportional to the seal load. The higher the seal load the faster the closure member 12 must close. The closure member 12 must have enough inertia to compress the at least one closure member seal 57 to travel to the latch secondary position and then hold that position until the latch 83 cinches. Using control logic that learns the close position on every cycle, as discussed below, the system 20 can be aware of cycles where it closes directly to primary position and self-adjust the speed of the closure member 12 as it closes. This can maintain soft close performance of the closure member 12.

In more detail and according to an aspect, the controller 50 is further configured to move the closure member 12 toward the closed position and move vehicle latch 83 to the latch secondary position in response to receiving an automatic mode initiation input to close the closure member 12. The controller 50 is also configured to measure at least one of the current of the electric motor 36 versus an actual current time period or the speed of the closure member 12 versus an actual motion time period while the closure member 12 is moving toward the closed position and compare the at least one of the current of the electric motor 36 versus the actual current time period to the predetermined current profile or the speed of the of the closure member 12 versus the actual motion time period to the predetermined current profile. The controller 50 is adjusts the speed of the closure member 12 moving toward the closed position based on at least one of at least one of the comparison of current of the electric motor 36 versus the actual current time period to the predetermined current profile or the comparison of the speed of the closure member 12 versus the actual motion time period to the predetermined current profile.

As discussed above, the vehicle latch 83 is configured to cinch the closure member 12 into the closed position from the partially closed position. To maintain such soft close performance, a logic flag can be used that determines if the latch 83 completed a cinch cycle on each power door close cycle. This can be determined, for example, by measuring time between secondary and primary latch signal, looking for cinch signal on a vehicle bus (e.g., controller area network, CAN) from the vehicle 10, monitoring latch motor current as mentioned above, etc. If the flag is not present for more than a predetermined flag count threshold TBD of cycles (e.g., 10 cycles), then the controller 50 can revert to a pre-calibrated slower door close algorithm (in development, the speed of the closure member 12 can be calibrated for multiple seal loads in anticipation of vehicle performance). So, according to another aspect of the disclosure, the controller 50 is further configured to set a logic flag corresponding to whether the vehicle latch 83 has completed cinching the closure member 12 in each of a plurality of power closure member close cycles.

According to other aspects, the controller 50 is further configured to set the logic flag to a yes Y in response to determining the at least one of the current of the electric motor 36 versus the actual current time period is equal to the predetermined current profile and the speed of the of the closure member 12 versus the actual motion time period is equal to the predetermined current profile. In addition, the controller 50 is configured to set the logic flag to a first no No_1 in response to determining the at least one of the current of the electric motor 36 versus the actual current time period is lower than the predetermined current profile and the speed of the of the closure member 12 versus the actual motion time period is higher than the predetermined current profile. The controller 50 is also configured to set the logic flag to a second no No_2 in response to determining the at least one of the current of the electric motor 36 versus the actual current time period is higher than the predetermined current profile and the speed of the of the closure member 12 versus the actual motion time period is lower than the predetermined current profile.

According to additional aspects of the disclosure, the controller 50 is further configured to check a flag count of a logic flag in response to receiving an automatic mode initiation input to close the closure member 12. The controller 50 moves the closure member 12 toward the closed position and determines whether at least one of the current of the electric motor 36 is not within a predetermined current threshold as compared to the predetermined current specification or the speed of the closure member 12 is not within a predetermined motion threshold as compared to the predetermined motion specification while the closure member 12 is moving toward the closed position. The controller sets the logic flag to a yes Y and returns to move the closure member 12 toward the closed position in response to determining the at least one of the current of the electric motor 36 is within the predetermined current threshold as compared to the predetermined current specification or the speed of the closure member 12 is within the predetermined motion threshold as compared to the predetermined motion specification while the closure member 12 is moving toward the closed position. The controller 50 is further configured to set the logic flag to one of a first no No_1 or a second no No_2 in response to determining the at least one of the current of the electric motor 36 is not within the predetermined current threshold as compared to the predetermined current specification or the speed of the closure member 12 is not within the predetermined motion threshold as compared to the predetermined motion specification while the closure member 12 is moving toward the closed position.

In addition, the controller 50 may further be configured to set the logic flag to the first no No_1 in response to determining the current of the electric motor 36 lower than the predetermined current specification and the speed of the closure member 12 is higher than the predetermined motion specification while the closure member 12 is moving toward the closed position. The controller 50 can also set the logic flag to the second no No_2 in response to determining the current of the electric motor 36 higher than the predetermined current specification and the speed of the closure member 12 is lower than the predetermined motion specification while the closure member 12 is moving toward the closed position.

According to one aspect, the logic flag being set to the first no No_1 corresponds to the seal load of the at least one closure member seal 57 being decreased from a calibrated value of the seal load. The logic flag being set to the second no No_2 corresponds to the seal load of the at least one closure member seal 57 being increased from the calibrated value of the seal load.

According to other aspects, the controller 50 is further configured to count the flag count of ones of the logic flag set to one of the first no No_1 and the second no No_2 and determine whether the flag count is greater than a predetermined flag count threshold. The controller 50 is additionally configured to return to move the closure member 12 toward the closed position in response to determining the flag count is not greater than the predetermined flag count threshold. The controller 50 updates a calibration profile associated with at least one of the current of the electric motor 36 or the speed of the closure member 12 in response to determining the flag count is greater than the predetermined flag count threshold. The controller 50 is also configured to reset the flag count and return to move the closure member 12 toward the closed position in response to determining the flag count is greater than the predetermined flag count threshold.

Therefore, if the weather changes and the seal force or load of the at least one closure member seal 57 increases (in winter, for example), the controller 50 can monitor the logic flag (secondary position flag). If the closure member 12 does not reach secondary after the predetermined flag count threshold TBD (e.g., 1 or 2 cycles), the controller 50 can increase the speed of the closure member 12 as it closes in response to higher seal load. It may be noted that the number of cycles in this case should be much lower as the failure mode of not reaching secondary is the closure member 12 will bounce open. This will cause customer annoyance.

According to further aspects, the predetermined motion specification for the speed of the closure member 12 includes a plurality of predetermined motion profiles of the speed of the closure member 12 versus a predetermined motion time period. The predetermined current specification includes a plurality of predetermined current profiles of the current of the electric motor 36 versus a predetermined current time period. So, the controller 50 may be further configured to select one of the plurality of predetermined motion profiles based on the current of the electric motor 36 sensed by the motor current sensor 86 and select one of plurality of predetermined motion profiles based on the speed of the closure member 12 detected by the closure member feedback sensor 64 in response to determining the flag count is greater than the predetermined flag count threshold.

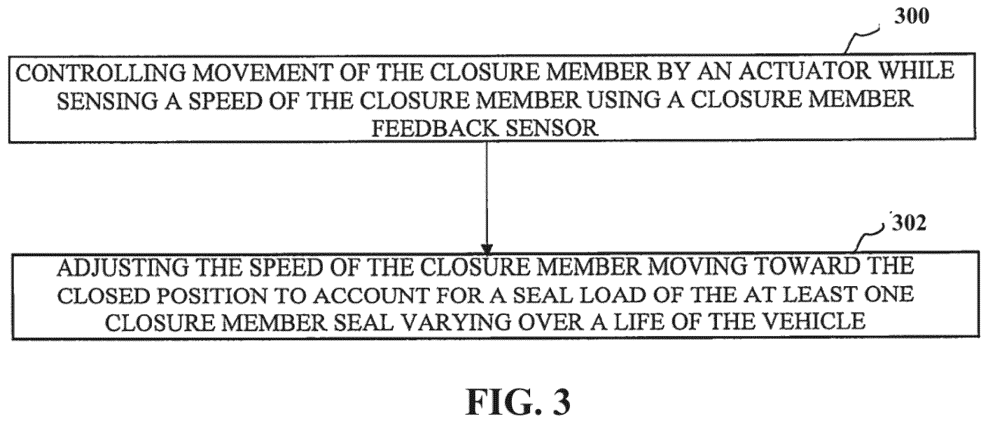

FIGS. 3-5 illustrate steps of a method of operating a power closure member actuation system 20 for moving a closure member 12 of a vehicle 10 between an open position and a closed position relative to a vehicle body 14. Again, the closure member 12 is sealed by at least one closure member seal 57 disposed between the closure member 12 and the vehicle body 14. Referring initially to FIG. 3, the method includes the step of 300 controlling movement of the closure member 12 by an actuator 22 while sensing a speed of the closure member 12 using a closure member feedback sensor 64. The method also includes the step of 302 adjusting the speed of the closure member 12 moving toward the closed position to account for a seal load of the at least one closure member seal 57 varying over a life of the vehicle 10.

Again, the power closure member actuation system 20 can further include a vehicle latch 83 configured to selectively secure the closure member 12 to the vehicle body 14. The vehicle latch 83 is movable between a latch primary position in which the closure member 12 is located in the closed position and a latch secondary position in which the closure member 12 is located in a partially closed position between the open position and the closed position. Thus, according to an aspect, the method further includes the step of adjusting the speed of the closure member 12 moving toward the closed position to prevent the closure member 12 from moving the vehicle latch 83 directly to the latch primary position.

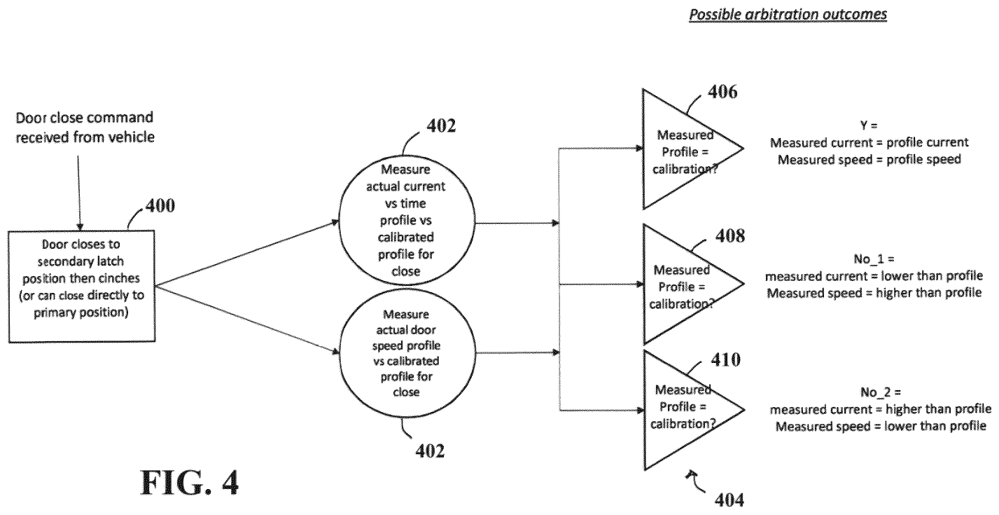

As discussed above, the actuator 22 may include an electric motor 36 operably coupled to the closure member 12 and the power closure member actuation system 20 can further includes a motor current sensor 86 coupled to the electric motor 36 for sensing a current provided to the electric motor 36 during movement of the closure member 12. Also, as above, the power closure member actuation system 20 includes a memory device 92 of a controller 50 storing a predetermined motion profile of the speed of the closure member 12 versus a predetermined motion time period and a predetermined current profile of the current of the electric motor 36 versus a predetermined current time period. Therefore, according to other aspects and referring specifically to FIG. 4, the method further includes the step of 400 moving the closure member 12 toward the closed position and move vehicle latch 83 to the latch secondary position (or can close directly to the primary latch position) in response to receiving an automatic mode initiation input to close the closure member 12. The method additionally includes the step of 402 measuring at least one of the current of the electric motor 36 versus an actual current time period or the speed of the closure member 12 versus an actual motion time period while the closure member 12 is moving toward the closed position and comparing the at least one of the current of the electric motor 36 versus the actual current time period to the predetermined current profile or the speed of the of the closure member 12 versus the actual motion time period to the predetermined current profile. The method also includes the step of 404 adjusting the speed of the closure member 12 moving toward the closed position based on at least one of at least one of the comparison of current of the electric motor 36 versus the actual current time period to the predetermined current profile or the comparison of the speed of the closure member 12 versus the actual motion time period to the predetermined current profile.

Once again, the vehicle latch 83 is configured to cinch the closure member 12 into the closed position from the partially closed position. Therefore, according to an aspect, the method further includes the step of setting a logic flag corresponding to whether the vehicle latch 83 has completed cinching the closure member 12 in each of a plurality of power closure member close cycles.

Still referring to FIG. 4 and according to further aspects, the method can additionally include the step of 406 setting the logic flag to a yes Y in response to determining the at least one of the current of the electric motor 36 versus the actual current time period is equal to the predetermined current profile and the speed of the of the closure member 12 versus the actual motion time period is equal to the predetermined current profile. Next, 408 setting the logic flag to a first no No_1 in response to determining the at least one of the current of the electric motor 36 versus the actual current time period is lower than the predetermined current profile and the speed of the of the closure member 12 versus the actual motion time period is higher than the predetermined current profile. The method also includes the step of 410 setting the logic flag to a second no No_2 in response to determining the at least one of the current of the electric motor 36 versus the actual current time period is higher than the predetermined current profile and the speed of the of the closure member 12 versus the actual motion time period is lower than the predetermined current profile.

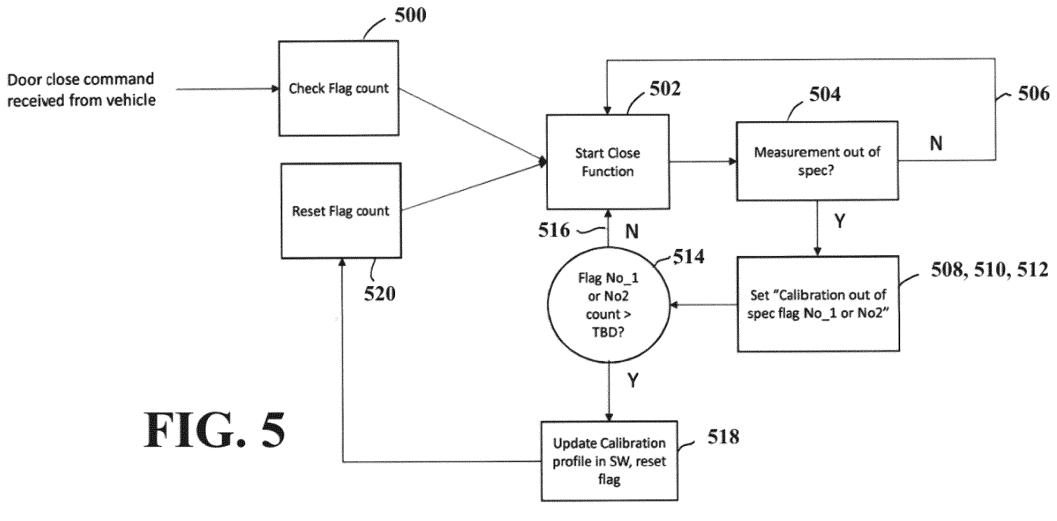

As discussed above, the actuator 22 includes an electric motor 36 operably coupled to the closure member 12 and the power closure member actuation system 20 further includes a motor current sensor 86 coupled to the electric motor 36 for sensing a current provided to the electric motor 36 during movement of the closure member 12. The controller 50 can also include a memory device 92 storing a predetermined motion specification for the speed of the closure member 12 and a predetermined current specification for the current of the electric motor 36. Therefore, referring specifically to FIG. 5, the method further includes the step of 500 checking a flag count of a logic flag in response to receiving an automatic mode initiation input to close the closure member 12. The method proceeds with the step of 502 moving the closure member 12 toward the closed position. Next, 504 determining whether at least one of the current of the electric motor 36 is not within a predetermined current threshold as compared to the predetermined current specification or the speed of the closure member 12 is not within a predetermined motion threshold as compared to the predetermined motion specification while the closure member 12 is moving toward the closed position. Next, the method includes the step of 506 setting the logic flag to a yes Y and returning to 502 moving the closure member 12 toward the closed position in response to determining the at least one of the current of the electric motor 36 is within the predetermined current threshold as compared to the predetermined current specification or the speed of the closure member 12 is within the predetermined motion threshold as compared to the predetermined motion specification while the closure member 12 is moving toward the closed position. The method also includes the step of 508 setting the logic flag to one of a first no No_1 or a second no No_2 in response to determining the at least one of the current of the electric motor 36 is not within the predetermined current threshold as compared to the predetermined current specification or the speed of the closure member 12 is not within the predetermined motion threshold as compared to the predetermined motion specification while the closure member 12 is moving toward the closed position.

In more detail and according to further aspects, the method includes the step of 510 setting the logic flag to the first no No_1 in response to determining the current of the electric motor 36 lower than the predetermined current specification and the speed of the closure member 12 is higher than the predetermined motion specification while the closure member 12 is moving toward the closed position. In addition, the method includes the step of 512 setting the logic flag to the second no No_2 in response to determining the current of the electric motor 36 higher than the predetermined current specification and the speed of the closure member 12 is lower than the predetermined motion specification while the closure member 12 is moving toward the closed position.

As above, the logic flag being set to the first no No_1 corresponds to the seal load of the at least one closure member seal 57 being decreased from a calibrated value of the seal load. The logic flag being set to the second no No_2 corresponds to the seal load of the at least one closure member seal 57 being increased from the calibrated value of the seal load.

According to further aspects, the method further includes the step of 514 counting the flag count of ones of the logic flag set to one of the first no No_1 and the second no No_2 and determining whether the flag count is greater than a predetermined flag count threshold. Next, 516 returning to 502 moving the closure member 12 toward the closed position in response to determining the flag count is not greater than the predetermined flag count threshold. The method continues by 518 updating a calibration profile associated with at least one of the current of the electric motor 36 or the speed of the closure member 12 in response to determining the flag count is greater than the predetermined flag count threshold. So, the memory device 92 of the controller 50 can store multiple calibrations. Updates to change the calibration may be done only after the predetermined flag count threshold TBD amount of consecutive No_X (first or second no) values. For example, if there are 5 consecutive first no No_1 logic flags, the controller 50 can identify reduced seal load and slow down the closure member 12 into the secondary latch position to maintain smooth closing function. This can be consistently adjusted as seal load can change with temperature as well, so seasonal adjustment is possible. The method also includes the step of 520 resetting the flag count and returning to 502 moving the closure member 12 toward the closed position in response to determining the flag count is greater than the predetermined flag count threshold.

Thus, the controller 50 will automatically implement a calibration profile based on measurement values. As mentioned above, the predetermined motion specification for the speed of the closure member 12 includes a plurality of predetermined motion profiles of the speed of the closure member 12 versus a predetermined motion time period and the predetermined current specification includes a plurality of predetermined current profiles of the current of the electric motor 36 versus a predetermined current time period. Thus, according to aspects of the disclosure, the method further includes the step of selecting one of the plurality of predetermined motion profiles based on the current of the electric motor 36 sensed by the motor current sensor 86 and select one of plurality of predetermined motion profiles based on the speed of the closure member 12 detected by the closure member feedback sensor 64 in response to determining the flag count is greater than the predetermined flag count threshold.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “controller” as used in this application is comprehensive of any such computer, processor, microchip processor, integrated circuit, or any other element(s), whether singly or in multiple parts, capable of carrying programming for performing the functions, methods and flowcharts provided herein. The controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

What is claimed is:

1. A power closure member actuation system for moving a closure member of a vehicle between an open position and a closed position relative to a vehicle body and sealed by at least one closure member seal disposed between the closure member and the vehicle body, the power closure member actuation system comprising:
an actuator coupled to the closure member and the vehicle body configured to move the closure member relative to the vehicle body;
a closure member feedback sensor for determining at least one of a position and a speed of the closure member; and
a controller in communication with the closure member feedback sensor and the actuator, the controller configured to:
control movement of the closure member by the actuator while sensing the speed of the closure member using the closure member feedback sensor, and
adjust the speed of the closure member moving toward the closed position to account for a seal load of the at least one closure member seal varying over a life of the vehicle.

2. The power closure member actuation system as set forth in claim 1, further including a vehicle latch configured to selectively secure the closure member to the vehicle body, wherein the vehicle latch is movable between a latch primary position in which the closure member is located in the closed position and a latch secondary position in which the closure member is located in a partially closed position between the open position and the closed position, and the controller is further configured to adjust the speed of the closure member moving toward the closed position to prevent the closure member from moving the vehicle latch directly to the latch primary position.

3. The power closure member actuation system as set forth in claim 1, further including a vehicle latch configured to selectively secure the closure member to the vehicle body, wherein the vehicle latch is movable between a latch primary position in which the closure member is located in the closed position and a latch secondary position in which the closure member is located in a partially closed position between the open position and the closed position, the actuator includes an electric motor operably coupled to the closure member and the power closure member actuation system further includes a motor current sensor coupled to the electric motor for sensing a current provided to the electric motor during movement of the closure member, the controller includes a memory device storing a predetermined motion profile of the speed of the closure member versus a predetermined motion time period and a predetermined current profile of the current of the electric motor versus a predetermined current time period, and the controller is further configured to:
move the closure member toward the closed position and move vehicle latch to the latch secondary position in response to receiving an automatic mode initiation input to close the closure member;
measure at least one of the current of the electric motor versus an actual current time period or the speed of the closure member versus an actual motion time period while the closure member is moving toward the closed position and compare the at least one of the current of the electric motor versus the actual current time period to the predetermined current profile or the speed of the of the closure member versus the actual motion time period to the predetermined current profile;
adjust the speed of the closure member moving toward the closed position based on at least one of at least one of the comparison of the current of the electric motor versus the actual current time period to the predetermined current profile or the comparison of the speed of the closure member versus the actual motion time period to the predetermined current profile.

4. The power closure member actuation system as set forth in claim 3, wherein the vehicle latch is configured to cinch the closure member into the closed position from the partially closed position, and the controller is further configured to set a logic flag corresponding to whether the vehicle latch has completed cinching the closure member in each of a plurality of power closure member close cycles.

5. The power closure member actuation system as set forth in claim 4, wherein the controller is further configured to:
set the logic flag to a yes in response to determining the at least one of the current of the electric motor versus the actual current time period is equal to the predetermined current profile and the speed of the of the closure member versus the actual motion time period is equal to the predetermined current profile;
set the logic flag to a first no in response to determining the at least one of the current of the electric motor versus the actual current time period is lower than the predetermined current profile and the speed of the of the closure member versus the actual motion time period is higher than the predetermined current profile; and
set the logic flag to a second no in response to determining the at least one of the current of the electric motor versus the actual current time period is higher than the predetermined current profile and the speed of the of the closure member versus the actual motion time period is lower than the predetermined current profile.

6. The power closure member actuation system as set forth in claim 1, wherein the actuator includes an electric motor operably coupled to the closure member and the power closure member actuation system further includes a motor current sensor coupled to the electric motor for sensing a current provided to the electric motor during movement of the closure member, the controller includes a memory device storing a predetermined motion specification for the speed of the closure member and a predetermined current specification for the current of the electric motor, and the controller is further configured to:
check a flag count of a logic flag in response to receiving an automatic mode initiation input to close the closure member;
move the closure member toward the closed position;
determine whether at least one of the current of the electric motor is not within a predetermined current threshold as compared to the predetermined current specification or the speed of the closure member is not within a predetermined motion threshold as compared to the predetermined motion specification while the closure member is moving toward the closed position;
set the logic flag to a yes and return to move the closure member toward the closed position in response to determining the at least one of the current of the electric motor is within the predetermined current threshold as compared to the predetermined current specification or the speed of the closure member is within the predetermined motion threshold as compared to the predetermined motion specification while the closure member is moving toward the closed position; and
set the logic flag to one of a first no or a second no in response to determining the at least one of the current of the electric motor is not within the predetermined current threshold as compared to the predetermined current specification or the speed of the closure member is not within the predetermined motion threshold as compared to the predetermined motion specification while the closure member is moving toward the closed position.

7. The power closure member actuation system as set forth in claim 6, wherein the controller is further configured to:
set the logic flag to the first no in response to determining the current of the electric motor lower than the predetermined current specification and the speed of the closure member is higher than the predetermined motion specification while the closure member is moving toward the closed position; and
set the logic flag to the second no in response to determining the current of the electric motor higher than the predetermined current specification and the speed of the closure member is lower than the predetermined motion specification while the closure member is moving toward the closed position.

8. The power closure member actuation system as set forth in claim 7, wherein the logic flag being set to the first no corresponds to the seal load of the at least one closure member seal being decreased from a calibrated value of the seal load and the logic flag being set to the second no corresponds to the seal load of the at least one closure member seal being increased from the calibrated value of the seal load.

9. The power closure member actuation system as set forth in claim 6, wherein the controller is further configured to:
count the flag count of ones of the logic flag set to one of the first no and the second no and determine whether the flag count is greater than a predetermined flag count threshold;
return to move the closure member toward the closed position in response to determining the flag count is not greater than the predetermined flag count threshold;
update a calibration profile associated with at least one of the current of the electric motor 36 or the speed of the closure member in response to determining the flag count is greater than the predetermined flag count threshold; and
reset the flag count and return to move the closure member toward the closed position in response to determining the flag count is greater than the predetermined flag count threshold.

10. The power closure member actuation system as set forth in claim 9, wherein the predetermined motion specification for the speed of the closure member includes a plurality of predetermined motion profiles of the speed of the closure member versus a predetermined motion time period and the predetermined current specification includes a plurality of predetermined current profiles of the current of the electric motor versus a predetermined current time period, and the controller is further configured to select one of the plurality of predetermined motion profiles based on the current of the electric motor sensed by the motor current sensor and select one of plurality of predetermined motion profiles based on the speed of the closure member detected by the closure member feedback sensor in response to determining the flag count is greater than the predetermined flag count threshold.

11. A method of operating a power closure member actuation system for moving a closure member of a vehicle between an open position and a closed position relative to a vehicle body and sealed by at least one closure member seal disposed between the closure member and the vehicle body, the method comprising:
controlling movement of the closure member by an actuator while sensing a speed of the closure member using a closure member feedback sensor; and
adjusting the speed of the closure member moving toward the closed position to account for a seal load of the at least one closure member seal varying over a life of the vehicle.

12. The method as set forth in claim 11, wherein the power closure member actuation system further includes a vehicle latch configured to selectively secure the closure member to the vehicle body, the vehicle latch is movable between a latch primary position in which the closure member is located in the closed position and a latch secondary position in which the closure member is located in a partially closed position between the open position and the closed position, and the method further includes the step of adjusting the speed of the closure member moving toward the closed position to prevent the closure member from moving the vehicle latch directly to the latch primary position.

13. The method as set forth in claim 11, wherein the power closure member actuation system further includes a vehicle latch configured to selectively secure the closure member to the vehicle body, wherein the vehicle latch is movable between a latch primary position in which the closure member is located in the closed position and a latch secondary position in which the closure member is located in a partially closed position between the open position and the closed position, the actuator includes an electric motor operably coupled to the closure member and the power closure member actuation system further includes a motor current sensor coupled to the electric motor for sensing a current provided to the electric motor during movement of the closure member, the power closure member actuation system includes a memory device storing a predetermined motion profile of the speed of the closure member versus a predetermined motion time period and a predetermined current profile of the current of the electric motor versus a predetermined current time period, and the method further includes the steps of:
moving the closure member toward the closed position and move vehicle latch to the latch secondary position in response to receiving an automatic mode initiation input to close the closure member;
measuring at least one of the current of the electric motor versus an actual current time period or the speed of the closure member versus an actual motion time period while the closure member is moving toward the closed position and comparing the at least one of the current of the electric motor versus the actual current time period to the predetermined current profile or the speed of the of the closure member versus the actual motion time period to the predetermined current profile;
adjusting the speed of the closure member moving toward the closed position based on at least one of at least one of the comparison of current of the electric motor versus the actual current time period to the predetermined current profile or the comparison of the speed of the closure member versus the actual motion time period to the predetermined current profile.

14. The method as set forth in claim 13, wherein the vehicle latch is configured to cinch the closure member into the closed position from the partially closed position, and the method further includes the step of setting a logic flag corresponding to whether the vehicle latch has completed cinching the closure member in each of a plurality of power closure member close cycles.

15. The method as set forth in claim 14, further including the steps of:
setting the logic flag to a yes in response to determining the at least one of the current of the electric motor versus the actual current time period is equal to the predetermined current profile and the speed of the of the closure member versus the actual motion time period is equal to the predetermined current profile;
setting the logic flag to a first no in response to determining the at least one of the current of the electric motor versus the actual current time period is lower than the predetermined current profile and the speed of the of the closure member versus the actual motion time period is higher than the predetermined current profile; and
setting the logic flag to a second no in response to determining the at least one of the current of the electric motor versus the actual current time period is higher than the predetermined current profile and the speed of the of the closure member versus the actual motion time period is lower than the predetermined current profile.

16. The method as set forth in claim 11, wherein the actuator includes an electric motor operably coupled to the closure member and the power closure member actuation system further includes a motor current sensor coupled to the electric motor for sensing a current provided to the electric motor during movement of the closure member, the power closure member actuation system includes a memory device storing a predetermined motion specification for the speed of the closure member and a predetermined current specification for the current of the electric motor, and the method further includes the steps of:
checking a flag count of a logic flag in response to receiving an automatic mode initiation input to close the closure member;
moving the closure member toward the closed position;
determining whether at least one of the current of the electric motor is not within a predetermined current threshold as compared to the predetermined current specification or the speed of the closure member is not within a predetermined motion threshold as compared to the predetermined motion specification while the closure member is moving toward the closed position;
setting the logic flag to a yes and returning to moving the closure member toward the closed position in response to determining the at least one of the current of the electric motor is within the predetermined current threshold as compared to the predetermined current specification or the speed of the closure member is within the predetermined motion threshold as compared to the predetermined motion specification while the closure member is moving toward the closed position; and
setting the logic flag to one of a first no or a second no in response to determining the at least one of the current of the electric motor is not within the predetermined current threshold as compared to the predetermined current specification or the speed of the closure member is not within the predetermined motion threshold as compared to the predetermined motion specification while the closure member is moving toward the closed position.

17. The method as set forth in claim 16, wherein further including the steps of:
setting the logic flag to the first no in response to determining the current of the electric motor lower than the predetermined current specification and the speed of the closure member is higher than the predetermined motion specification while the closure member is moving toward the closed position; and
setting the logic flag to the second no in response to determining the current of the electric motor higher than the predetermined current specification and the speed of the closure member is lower than the predetermined motion specification while the closure member is moving toward the closed position.

18. The method as set forth in claim 17, wherein the logic flag being set to the first no corresponds to the seal load of the at least one closure member seal being decreased from a calibrated value of the seal load and the logic flag being set to the second no corresponds to the seal load of the at least one closure member seal being increased from the calibrated value of the seal load.

19. The method as set forth in claim 16, further including the steps of:
counting the flag count of ones of the logic flag set to one of the first no and the second no and determining whether the flag count is greater than a predetermined flag count threshold;
returning to moving the closure member toward the closed position in response to determining the flag count is not greater than the predetermined flag count threshold;
updating a calibration profile associated with at least one of the current of the electric motor or the speed of the closure member in response to determining the flag count is greater than the predetermined flag count threshold; and
resetting the flag count and returning to moving the closure member toward the closed position in response to determining the flag count is greater than the predetermined flag count threshold.

20. The method as set forth in claim 19, wherein the predetermined motion specification for the speed of the closure member includes a plurality of predetermined motion profiles of the speed of the closure member versus a predetermined motion time period and the predetermined current specification includes a plurality of predetermined current profiles of the current of the electric motor versus a predetermined current time period, and the method further includes the step of selecting one of the plurality of predetermined motion profiles based on the current of the electric motor sensed by the motor current sensor and select one of plurality of predetermined motion profiles based on the speed of the closure member detected by the closure member feedback sensor in response to determining the flag count is greater than the predetermined flag count threshold.
